(19) United States
(12) Patent Application Publication
(10) Pub. No.: US 2026/0127158 A1
(43) Pub. Date: May 7, 2026

(54) MULTIMODAL RETRIEVAL BASED ON RELATIONAL MODELING OF ATOMIC DOCUMENT ELEMENTS

(71) Applicant: Cohere Health, Inc., Boston, MA (US)

(72) Inventors: Jackson Mostoller, Surprise, AZ (US); Parth Anand Jawale, Seattle, WA (US); Isaac Lo, San Francisco, CA (US); Ben Barone, West Fulton, NY (US)

(73) Assignee: Cohere Health, Inc., Boston, MA (US)

(21) Appl. No.: 19/376,731

(22) Filed: Oct. 31, 2025

Related U.S. Application Data
(60) Provisional application No. 63/715,425, filed on Nov. 1, 2024.

(51) Int. Cl. G06F 16/23; G06F 16/28; G06F 40/205

(52) U.S. Cl. CPC G06F 16/235; G06F 16/284; G06F 40/205

(57) ABSTRACT

An atomic relational retrieval system can determine a type of modality for each document of a plurality of documents having unstructured data. The system can route each document to a parser based on the type of modality. The system can parse at least the unstructured data of each document according to an atomic unit type to extract a plurality of atomic units from the document and a plurality of attributes of each atomic unit. The system can update a table in a relational database to include a record for each atomic unit, the record including a unique identifier of the atomic unit, a document identifier linking the atomic unit to its source document, and the plurality of attributes. The system can output, in response to a request for a chunk of one or more atomic units, at least one record corresponding to the chunk, the chunk is dynamically defined.

### CROSS-REFERENCE TO RELATED APPLICATIONS

The present application claims the benefit of and priority to U.S. Provisional Application No. 63/715,425, filed Nov. 1, 2024, the disclosure of which is incorporated herein by reference in its entirety.

### BACKGROUND

Information retrieval systems are used to manage, store, and retrieve large volumes of digital data from diverse sources. Unstructured data such as text, images, audio, and other multimedia formats often require specialized tools for processing and searching. However, existing systems face difficulties in handling heterogeneous data types, maintaining metadata consistency, and enabling efficient retrieval across different modalities. This can lead to retrieval that lacks in performance in speed, compute requirements, and/or data storage requirements.

### SUMMARY

Systems and methods in accordance with the present disclosure can represent documents and their components as relational data, including by extracting atomic units of data in any of a variety of modalities, and grouping, e.g., chunking, the atomic units into chunks to respond to queries for data retrieval. For example, the system can provide dynamic view-based chunking in which the chunks are provided as views over the atomic units, rather than relying on chunks that are fixed at indexing of the documents. This can allow for variable granularity of retrieval without re-indexing. Metadata, including spatial and semantic annotations, can be associated with atomic units directly, and can be aggregated at the chunk level through relational joins or grouping operations. In response to a query, retrieval operations can be expressed as composable relational expressions that select, filter, or aggregate atomic and chunk-level attributes from a unified multimodal corpus. This can allow for flexible and consistent information access across different data types. The system can allow for multi-stage retrieval operations, which can allow for more efficient retrieval of relevant data. For example, systems and methods as described herein can achieve faster retrieval, including with fewer requirements for intermediate data to be stored or maintained. Systems and methods in accordance with the present disclosure can be applied to retrieval tasks in any of a variety of applications, including but not limited to document generation or processing, classification, clinical workflows, administrative workflows, healthcare operations including prior authorization, scheduling, patient support, clinician support, claims processing, chart or lab processing, report generation, conversational agent management, or various combinations thereof.

At least one aspect relates to a system. The system can receive a plurality of documents comprising unstructured data. The system can determine a type of modality for each document of the plurality of documents. The system can route each document to a corresponding parser based on the type of modality for the document. The system can select an atomic unit type for parsing each document based on the type of modality. The system can parse at least the unstructured data of each document according to the atomic unit type to extract a plurality of atomic units from the document and a plurality of attributes of each atomic unit. The system can update a table in a relational database to include a record for each atomic unit, the record including a unique identifier of the atomic unit, a document identifier linking the atomic unit to the document from which the atomic unit is extracted, and the plurality of attributes of the atomic unit. The system can output, in response to a request for a chunk of one or more atomic units, at least one record corresponding to the chunk, where the chunk is dynamically defined responsive to the request.

In some implementations, the system can dynamically define the chunk as a selection of one or more atomic units based on one or more criteria indicated by the request. In some implementations, the system can represent the chunk as a first table comprising one or more chunk-level attributes of the chunk and a second table comprising an identifier of the chunk and the unique identifier of each atomic unit of the chunk. In some implementations, the system can output the chunk, based on the request, to include atomic units of a plurality of modalities. In some implementations, the request can be a first request indicating one or more first criteria for selection of atomic units, and the system can output responsive to a second request indicating one or more second criteria, a subset of the atomic units of the chunk. In some implementations, the system can provide, for generation of the request, a function to select atomic units according to a content attribute or a metadata attribute of the atomic units. In some implementations, the system can output the record to include both text data and image data. In some implementations, the system can generate the plurality of attributes of each atomic unit to include a location of the atomic unit in the document from which the atomic unit is extracted. In some implementations, the plurality of documents can include a plurality of modalities including at least a text modality and an image modality. In some implementations, the system can determine that the plurality of attributes of each atomic unit include at least one of a text value or a pixel color of the atomic unit and at least one of a position or a time stamp of the atomic unit. In some implementations, the atomic unit type can include a text token type, an image pixel type, or an audio sample type, and the system can use the corresponding parser to perform tokenization, pixel identification, or audio sampling of the document. In some implementations, the system can determine, based on the request, at least one of a relevance score, an embedding, a text representation, or a bounding box for the chunk.

At least one other aspect relates to a method. The method can be performed, for example, by one or more processors coupled to non-transitory memory. The method can include receiving a plurality of documents comprising unstructured data. The method can include determining a type of modality for each document of the plurality of documents. The method can include routing each document to a corresponding parser based on the type of modality for the document. The method can include selecting an atomic unit type for parsing each document based on the type of modality. The method can include parsing at least the unstructured data of each document according to the atomic unit type to extract a plurality of atomic units from the document and a plurality of attributes of each atomic unit. The method can include updating a table in a relational database to include a record for each atomic unit, the record including a unique identifier of the atomic unit, a document identifier linking the atomic unit to the document from which the atomic unit is extracted, and the plurality of attributes of the atomic unit. The method can include outputting, in response to a request for a chunk of one or more atomic units, at least one record corresponding to the chunk, the chunk being dynamically defined responsive to the request.

In some implementations, the method can include defining the chunk as a selection of one or more atomic units based on one or more criteria indicated by the request. In some implementations, the method can include structuring the chunk as a first table comprising one or more chunk-level attributes of the chunk and a second table comprising an identifier of the chunk and the unique identifier of each atomic unit of the chunk. In some implementations, the request can be a first request indicating one or more first criteria for selection of atomic units, and the method can include outputting responsive to a second request indicating one or more second criteria, a subset of the one or more atomic units of the chunk. In some implementations, the method can include providing for generation of the request a function to select atomic units according to a content attribute or a metadata attribute of the atomic units. In some implementations, the method can include generating the plurality of attributes of each atomic unit to include a location of the atomic unit in the document from which the atomic unit is extracted. In some implementations, the method can include determining that the plurality of attributes of each atomic unit include at least one of a text value or a pixel color of the atomic unit and at least one of a position or a time stamp of the atomic unit. In some implementations, the atomic unit type can include a text token type, an image pixel type, or an audio sample type, and the method can include using the corresponding parser to perform tokenization, pixel identification, or audio sampling of the document.

At least one aspect relates to a non-transitory computer-readable medium. The non-transitory computer-readable medium includes machine-readable instructions that when executed by one or more processors, cause the one or more processors to execute operations including parsing one or more documents, according to one or more modalities of the one or more documents, to extract a plurality of atomic units from the one or more documents and a plurality of attributes of each atomic unit of the plurality of atomic units; updating a table in a relational database to include a record for each atomic unit of the plurality of atomic units, the record comprising a unique identifier of the atomic unit, a document identifier linking the atomic unit to the document from which the atomic unit is extracted, and the plurality of attributes of the atomic unit; and outputting, based at least on a request for a chunk of one or more atomic units, at least a portion of at least one record corresponding to the chunk.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating an example of an atomic relational retrieval system, in accordance with one or more implementations;

FIG. 2 is a flow diagram of an example of an atomized relational retrieval process, in accordance with one or more implementations;

FIG. 3 is a flow diagram of an example of an atomized relational retrieval process, in accordance with one or more implementations; and

FIG. 4 is a flow chart illustrating a method of atomized relational retrieval, in accordance with one or more implementations.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

The present disclosure relates to techniques for representing unstructured or multimodal data in a relational format to enable flexible and fine-grained information retrieval. Data used in information retrieval systems can originate from diverse document types such as text, images, and audio recordings. Each type of data can include different structures, metadata, and content attributes, which can require the use of specific parsers or processing tools to extract information suitable for downstream retrieval tasks. Conventional information retrieval systems can operate on a document-level or file-level representation. Relational database management systems can, by contrast, provide structured access to tabular data with clear definitions for relationships, indexes, and attributes.

Existing information retrieval architectures can encounter technical challenges when managing heterogeneous data or performing search operations that rely on context-specific representations. For example, traditional indexing systems can create static indexes that depend on predetermined segmentation strategies or token-level splits. This can include, for example, relying on chunks defined at index time. When retrieval tasks require different chunk sizes or new relevance metrics, many systems must be rebuilt from scratch to accommodate the new configuration. Metadata such as positional coordinates, timestamps, or semantic annotations can become fragmented across different data stores, complicating relational queries. Furthermore, retrieval operations that span multiple modalities, such as combining text relevance with visual similarity, can require disparate processing pipelines, which can increase computational overhead, and can limit consistency of results across modalities.

The techniques described herein can address any of various such challenges by implementing a relational representation of unstructured information, such as at a granular level. For example, the system can extract atomic units from documents, such as tokens for text, pixels for images, or samples for audio. Each atomic unit can retain attributes such as identifiers, positional data, semantic embeddings, and/or other metadata fields. The system can store the atomic units as relational records, and can dynamically group atomic units into higher-level constructs such as chunks (e.g., groups of atomic units and/or data thereof). The system can define or represent chunks as relational views or expressions that reference subsets of atomic units according to selection criteria or specific application needs. Retrieval can therefore occur at variable levels of granularity without requiring re-indexing of the original corpus.

In some implementations, the system can maintain and/or update a relational storage structure that includes one or more tables representing atomic units (and/or attributes of atomic units) and one or more tables representing chunks (and/or attributes of chunks). The system can parse documents into atomic units based on modality-specific parsing logic, such as to use one or more parsers that correspond to the type(s) of modalities of the documents. Each atomic unit can be stored as a record in a relational table with unique identifiers and associated attributes. A retrieval component can transform user queries into relational expressions that filter, join, and/or aggregate the stored atomic records to reconstruct relevant chunks. Additional components can enrich chunks with derived attributes, such as relevance scores or embedding-based similarity metrics. In some implementations, because the system can define chunks as views rather than static entities, the same dataset can support multiple retrieval strategies without altering the underlying data (including, for example and without limitation, performing retrieval based on both page chunks and sentence chunks).

By applying relational modeling principles to unstructured data, the techniques described herein can provide significant technical improvements over conventional information retrieval pipelines. These improvements can include a unified representation that preserves all metadata as first-class query-accessible fields, dynamic and non-destructive chunking that eliminates the need for re-indexing, and/or the ability to integrate multimodal relevance signals within a single query framework. As a result, retrieval workloads can operate more efficiently, perform queries across multiple modalities with consistent semantics, and/or maintain precise traceability between retrieved chunks and the original atomic data. The system can apply atomic-level storage and dynamic relational retrieval to provide a more expressive and/or flexible foundation for multimodal information access.

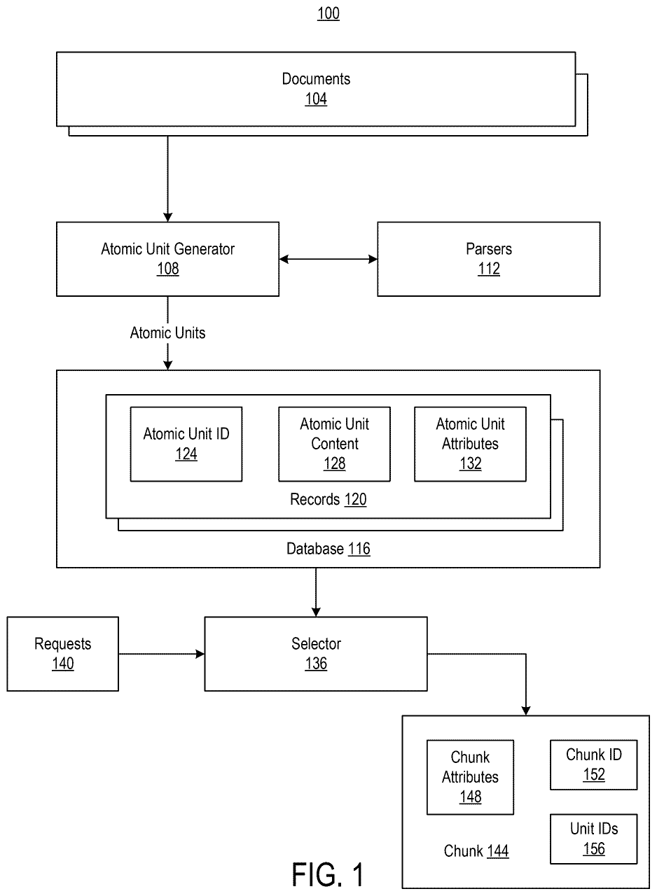

Referring now to FIG. 1, illustrated is a block diagram of an example system 100, such as an information retrieval system 100, in accordance with one or more implementations. The system 100 can perform retrieval of data from unstructured or multimodal sources using relational representations. For example, the system 100 can execute a retrieval pipeline for documents in any of a plurality of modalities or multiple modalities, such as any one or more of text, speech, audio, image, and/or video modalities. The system 100 can include or be operated using any of various computing hardware and/or software components, including but not limited to central processing unit (CPU) and/or graphics processing unit (GPU) systems. The system 100 can include one or more hardware and/or software components to execute operations described herein, such as one or more processors, hardware, software, databases, algorithms, functions, modules, neural networks, machine learning models, heuristics, policies, rules, or various combinations thereof. The system 100 can be structured as or to operate on any of various computing architectures, including, for example and without limitation, an on-premises system, a cloud-based system, a client-server architecture, a data center-based architecture, or various combinations thereof. The system 100 can handle retrieval for any of a variety of tasks, including but not limited to retrieval-based processes for language models, vision-language models or other vision or multimodal models, document generation or processing, classification, clinical workflows, administrative workflows, prior authorization, scheduling, patient support, clinician support, claims processing, chart or lab processing, report generation, conversational agent management, or various combinations thereof.

The system 100 can include or be coupled with at least one source of documents 104. The documents 104 can represent input content of various modalities, including text, speech, images, video, and audio. The documents 104 can be electronic data files. In some implementations, the documents 104 may include heterogeneous files of differing structures or encodings that require distinct parsing logic. For example, a corpus of digital files such as PDFs, scanned pages, or recorded signals can serve as the documents 104, and each file type may provide metadata indicating its structure or format. The documents 104 can include unstructured information, such as textual, visual, or temporal elements without predefined schema. In some implementations, each document 104 can include information of multiple modalities, such as text embedded within images or audio tracks accompanied by timestamped textual annotations, which the system 100 can process to extract distinct atomic units corresponding to each modality. In some implementations, the system 100 can receive and/or structure the documents 104 as a corpus of documents 104 (e.g., as described further herein, to structure the documents 104 as a collection of atomic units).

The system 100 can receive the documents 104 through a data ingestion interface. The system 100 can store references to each file in association with identifying attributes, such as file name, modality indicator, or source identifier. The system 100 can include or implement any of various database management components, including but not limited to SQL or functionality analogous to SQL, to facilitate data ingestion, processing, storing, and/or retrieval.

The system 100 can include an atomic unit generator 108. The atomic unit generator 108 can extract atomic units of data (e.g., atoms of data) from any one or more documents 104. The atomic units can be portions of the data of the documents 104, such as portions of the unstructured data of the documents 104. The system 100 can generate the atomic units to include or represent content from the documents 104. The system 100 can generate the atomic units to collectively represent all of the data of the documents 104, or subset of the data of the documents 104.

Each atomic unit can have an atomic unit type. The atomic unit type can correspond to a type of the data of the atomic unit. For example, the atomic unit type can include a text type, such as text tokens, or words, sentences, or paragraphs; an image and/or video type, such as pixels (or blocks or other groups of pixels); or an audio and/or speech type, such as samples of audio, such as segments of audio. For example, the atomic unit generator 108 can generate, from a given document 104, a plurality of atomic units having atomic unit types that correspond to the types of modalities of the given document 104.

In some implementations, the system 100 can include or be coupled with one or more parsers 112. The parsers 112 can parse the documents 104 to extract the atomic units. Each parser 112 can correspond to one or more types of modalities of the documents 104 and/or atomic unit types. The parsers 112 can perform preprocessing of documents 104, such as to process content of the documents 104, according to at least one type of modality of the document 104. In some implementations, the parsers 112 include at least one language model or embedding model, such as to generate tokens and/or vectors to represent (e.g., embed, encode) data of documents 104. In some implementations, each parser 112 can implement normalization or segmentation rules tailored to a specific modality type to prepare document content for atomic decomposition. For example, a parser 112 for textual input can divide sentences into token elements, a parser 112 for image input can detect pixels or region boundaries, and a parser 112 for audio input can divide waveform data into consecutive samples. In an example, a parser 112 applied to image-based text can use optical character recognition to identify character regions and associate coordinate metadata with extracted character tokens. Each parser 112 can provide the processed content to the atomic unit generator 108 for further transformation into atomic units (e.g., which the atomic unit generator 108 can represent in tables, e.g., records 120, of the database 116). In some implementations, one or more parsers 112 includes an optical character recognition (OCR) component. In some implementations, the atomic unit generator 108 includes one or more parsers 112.

The system 100 can route (e.g., transmit, direct) documents 104 and/or portions of documents 104, according to the modalit(ies) of the documents 104, to the corresponding parser 112 for the modalit(ies), such as to execute tokenization or segmentation functions. The system 100 can identify the corresponding parser 112 for each document 104 based on a detected modality of the document 104. For example, the system 100 can access metadata fields embedded in the documents 104 to identify an associated modality such as text, image, video, speech, or audio. For example, where the metadata specifies a text-based format, the system 100 can select the corresponding parser 112 that performs tokenization and sentence segmentation. Where the metadata specifies an image modality, the parser 112 can apply segmentation operations that determine pixel groupings or object boundaries for subsequent atomic processing. Each parser 112 can receive documents 104 through an automated routing process executed prior to atomic unit generation.

Referring further to FIG. 1, the atomic unit generator 108 can receive the output from one or more parsers 112, and can generate atomic representations of the output for relational storage. In some implementations, the atomic unit generator 108 can operate as a bridge between raw parsed content and structured relational data, creating a standardized representation compatible with relational database operations. The atomic unit generator 108 can interpret the tokenized or segmented output from modality-specific parsers and generate uniform data structures that encode both the content and contextual metadata of each atomic element.

For example, the atomic unit generator 108 can assign a unique atomic identifier (e.g., atomic unit ID 124) to each atomic unit (e.g. and without limitation, token, pixel, or audio sample), and can associate the unique atomic identifier with one or more attributes of the atomic unit, such as content or metadata of the atomic unit, including positional data, confidence metrics, and/or learned embedding vectors. These associations can allow for consistent and reproducible access to atomic data across retrieval sessions. The atomic unit generator 108 can further aggregate or normalize parser-generated attributes such as bounding box coordinates or timestamp values so that they can be stored as first-class relational attributes. The atomic unit generator 108 can execute iterative or streaming transformation processes that continuously process sequential segments of incoming data into atomic records, which can ensure that all relationally addressable elements are generated and captured in real time for storage or retrieval.

Referring further to FIG. 1, the system 100 can include a database 116. The database 116 can be a relational database and/or storage environment, which can maintain a corpus of atomic units. The system 100 can update the database 116 to represent atomic units generated by the atomic unit generator 108, e.g., as extracted from documents 104. In some implementations, the system 100 can use the database 116 as a foundational storage layer that supports query execution, relational joins, and/or aggregations over multimodal atomic data.

The system 100 can update the database 116 to include one or more records 120. The database 116 can include a table that indicates the records 120. Each record 120 can represent a corresponding atomic unit. In some implementations, the system 100 structures the database 116 and/or the records 120 to represent atomic units represented as rows in one or more interlinked tables. The database 116 can store a record 120 for each atomic unit extracted from the documents 104. Each record 120 can represent a granular relational entry corresponding to a single atomic unit generated from one of the documents 104. These records can act as the fundamental data blocks that capture all contextual and value-based information necessary for retrieval, enrichment, and recomposition of document fragments. In some implementations, each record 120 can include fields for the atomic unit ID 124, atomic unit content 128, and atomic unit attributes 132, such as to form an integrated schema that maintains direct relationships between a unit's identity, content, and metadata. For example, a record 120 may include a token from text with its unique ID, text string, and corresponding location data such as a character offset or bounding coordinates. These associations can also include document references that maintain a persistent link to the original unstructured file or source of extraction. The records 120 can thus function as base tables for relational operations-supporting selections, filters, joins, and aggregations used in retrieval workflows. As described further herein, the system 100 can receive and/or execute queries to compute aggregate statistics, apply relevance scoring functions, or generate chunk-level composites directly from fields defined within these records, enabling flexible and consistent access to atomic-level data throughout retrieval pipelines.

For example, the system 100 can assign, to each record 120, an atomic unit identifier (ID) 124, which can be a unique identifier for the atomic unit corresponding to the record 120. The atomic unit ID 124 can be a primary key for relational access. The atomic unit ID 124 can uniquely identify each atomic unit stored in the relational table and maintain referential integrity across all related data tables in the corpus. The system 100 can generate the atomic unit ID 124 can be generated using deterministic rules such as a composite of the document identifier, modality type, and intra-document offset, ensuring reproducible indexing across document updates. The system 100 can use the atomic unit ID 124 as a primary key used to join atomic unit records to metadata or chunk mappings and can facilitate relational operations that reconstruct semantic or structural groupings. For example, a paragraph or image region can be dynamically created by joining multiple atomic unit IDs 124 under a single chunk identifier (e.g., chunk ID 152). The atomic unit IDs 124 can provide consistency for cross-modal referencing; for example, a text token and an image region derived from the same page may be stored separately yet linked through the document identifiers to the document 104 of the page. Through these relationships, the atomic unit ID 124 enables traceability from high-level retrieval outputs back to the precise atomic elements that constitute them, which can support explainable and reproducible retrieval across modalities.

The system 100 can store, in each record 120, the corresponding data of the atomic unit as atomic unit content 128. The atomic unit content 128 can correspond to the extracted value of each atomic unit obtained from the documents 104, and can be used as the core payload for information retrieval. For example and without limitation, the system 100 can store text tokens, image pixels, and/or audio samples as the atomic unit content 128 (e.g., depending on the atomic unit type). Depending on modality, this content can represent a character sequence, a pixel intensity, or an audio waveform sample. In some implementations, the atomic unit content 128 can be stored as a normalized or tokenized value that allows semantic or numeric operations across units of different types. For text modalities, atomic unit content 128 can include tokens that are stored as strings or encoded representations for embedding or keyword-based processing. For image modalities, atomic unit content 128 may correspond to RGB or grayscale pixel values, while for audio modalities it may represent waveform samples or extracted spectral coefficients. These content fields can be fully queryable, enabling filtering or aggregation directly on the raw value while preserving associations with metadata. The system can join atomic unit content 128 with atomic unit attributes 132 to generate enriched outputs combining raw data and contextual descriptors, which allows retrieval processes to reconstruct text spans, image regions, or acoustic frames that satisfy specified relational criteria.

The system 100 can store, in each record 120, attributes of the atomic unit as atomic unit attributes 132. The attributes can include, for example and without limitation, an identifier of the document 104 from which the atomic unit was extracted, an indication of the atomic unit type of the atomic unit, positional attributes such as a relative or absolute location of the data (e.g., a position index, such as an ordinal position of the text in the document 104; pixel coordinates; time stamps of audio samples or image frames in video), confidence values associated with the parsing by parsers 112, such as OCR parsing scores; relevance scores; embedding vectors; similarity metrics; metadata extracted from the document 104; or various combinations thereof. For example, the atomic unit attributes 132 can include metadata and descriptive characteristics associated with each atomic unit, encompassing spatial, temporal, semantic, and confidence-related information. Using these attributes the system 100 can transform atomic content into richly annotated data elements, which can allow for advanced relational queries and contextual filtering. In some implementations, the atomic unit attributes 132 can include positional data such as coordinates or offsets within the original document, timestamps for audio or video frames, and derived values such as embedding vectors, semantic categories, or OCR confidence scores.

In some implementations, by storing metadata at the atomic level, the system 100 can allow for lossless preservation of spatial and structural details that can later be aggregated at higher levels. For example, the system 100 can execute retrieval queries to filter by bounding box coordinates, or can compute the mean semantic similarity of textual atoms within a given section. The atomic unit attributes 132 can also include both directly extracted and externally enriched data, allowing dynamic integration of additional information sources such as annotations, classifications, or relevance scores. This design allows the atomic unit attributes 132 to function as first-class fields in relational queries, enabling filtering, grouping, and ranking operations that combine content-based and metadata-based reasoning in a unified framework.

This structure of the database 116 and/or records 120 can allow for deterministic referencing and efficient reconstruction of higher-level document components. For example, the database 116 can include structured tables linking each atomic unit ID 124 with corresponding atomic unit content 128 and atomic unit attributes 132, forming extensible schemas capable of accommodating text, image, or audio-based information. The database 116 may maintain indexed columns on common attributes such as positional data, temporal identifiers, or semantic vectors to accelerate query performance. By leveraging these indexes, the system can efficiently perform complex relational queries such as grouping, joining, or aggregating atomic units to form higher-order chunks (e.g., chunks 144 as described further herein), such as pages, paragraphs, or regions of an image. Thus, the database 116 can serve as a comprehensive and modality-agnostic foundation for structured retrieval operations.

Table 1 below provides examples of records 120 representing atomic units:

| Atomic | | Atomic | Atomic | Atomic | Atomic |
|---|---|---|---|---|---|
| Unit | Document | Unit | Unit | Unit | Unit |
| ID | ID | Content | Attributes | Attributes | Attributes |
| (124) | (132) | (128) | (132) | (132) | (132) |
| 101 | D01 | token text: | position | confidence | |
| | | diabetes | index: 15 | score: | |
| | | | | 0.98 | |
| 205 | P12 | OCR | bounding | page | confidence |
| | | token text: | box: {40, | number: 3 | score: |
| | | aspirin | 120, 50, | | 0.97 |
| | | | 15} | | |
| 302 | IMG2 | x | y | color | region: |
| | | coordinate: | coordinate: | values | R09 |
| | | 35 | 72 | (RGB): | |
| | | | | 128, 64, | |
| | | | | 120 | |
| 409 | AUD5 | timestamp: | sample | sample | |
| | | 3.54 s | amplitude: | frequency: | |
| | | | 0.047 | 315 Hz | |

Referring further to FIG. 1, the system 100 can include a selector 136. The selector 136 can select groups of atomic units, such as chunks 144 of atomic units, in response to any of various trigger conditions. For example, the selector 136 can select groups of atomic units in response to one or more requests 140 as described herein. The selector 136 can select groups based on scheduled or dynamic processes. The selector 136 can define the groupings dynamically, such as in response to the requests 140 (e.g., rather than the groups being defined based on and/or only on predefined indexing or chunking).

The selector 136 can function as a query execution component that applies relational expressions to perform filtering, grouping, or joining operations over atomic data maintained in the database 116. In some implementations, the selector 136 can evaluate relational expressions that reference atomic attributes 132 to determine which atomic units satisfy one or more conditions derived from query parameters. For example, the selector 136 can execute a query defined by a user or a system process in response to a request 140, can apply predicate logic to atomic unit attributes 132, and can return corresponding records 120 satisfying those conditions.

In some implementations, the selector 136 includes or is coupled with at least one application programming interface (API), which can allow for functions or methods to be defined for configuration of and/or processing of requests 140. For example, the selector 136 can include methods for retrieving data from the database 116 including one or more of a chunk method, an enrich method, a filter method, and a select method. The selector 136 can access, in response to the chunk method, an existing collection of chunks 144 by name, or can generate new chunks 144 (e.g., via an expression). From the resulting chunks object, the enrich method can be used (e.g., by the selector 136) to persist new attributes to chunks 144. The filter method can remove chunks 144 based on attributes or expressions. The select method can assign chunk and atom metadata into a table for downstream use. The request 140 can be one or more requests in which any of various such methods of the selector 136 can be chained to construct complex data transformations.

The selector 136 (e.g., the API of the selector 136) can receive expressions that define functions or operations to compute. The expressions can be associated with the API. The expressions can include attribute expressions that represent chunk-level attributes (which, for example, the selector 136 can compute and can store as chunk attributes 148). The expressions can include chunk expressions, which can define chunking strategies over the atomic data units, such as sliding windows. The expressions can include chunk filter expressions, such as to define chunk filtering approaches such as top K or minimum thresholds that can be applied to existing chunk attributes 148 or for determination of chunk attributes 148. The expressions can be user-definable.

Referring further to FIG. 1, the system 100 can receive one or more requests 140 for data, e.g., atomic units, from the documents 104. The selector 136 can generate a response to the request 140, such as to output records 120 or data of records 120, according to one or more criteria indicated by the request 140. For example, the requests 140 can represent incoming retrieval expressions that define selection or grouping instructions for accessing atomic unit data within the database 116. In some implementations, each request 140 can specify retrieval parameters such as a collection name, atomic attribute filters, top-K constraints, or threshold values for one or more relevance attributes. For example, a request 140 can include parameters indicating search terms or embedding-based similarity conditions that identify atomic units to obtain or to combine into chunks 144. Each request 140 can serve as a query object containing composable expressions representing content selection logic, enrichment logic, or scoring stages. In some implementations, the requests 140 can originate from an application interface or an external system utilizing the corpus query application programming interface to initiate relational retrieval.

Referring further to FIG. 1, the selector 136 can generate a chunk 144 of atomic units. The selector 136 can generate the chunk 144 to be a data object. The chunk 144 can be a group, e.g., a collection, of atomic units, such as meaningful units to retrieve or reference (e.g., in response to a given request 140). For example, the selector 136 can generate the chunk 144 to include selected atomic units to meet attribute filters or aggregation criteria expressed by a retrieval request 140. As an example, the selector 136 can apply relational HAVING clauses to construct a chunk corresponding to a phrase, sentence, or paragraph, or can apply scalar and vector aggregation functions to compute one or more chunk-level results. The selector 136 can retrieve partial groupings or compound aggregations of atomic unit IDs 124, and can assign results to alias tables for use in subsequent query stages. In some implementations, the selector 136 can evaluate sequential queries or pipeline operations forming multi-stage retrieval workflows that allow distinct ranking expressions or attribute filters at successive retrieval stages.

The chunk 144 can represent a relational grouping or dynamically created view of atomic unit records, which can collectively form a retrieval unit for the response to a request 140. In some implementations, the chunk 144 can represent any subset of atomic units defined by expressions specifying spatial, temporal, or semantic boundaries. For example, the chunk 144 can correspond to a contiguous group of text tokens within a paragraph, a region of pixels in an image, or a selection of audio samples associated with a time interval. The selector 136 can assign a chunk identifier 152 to the chunk 144 as a unique identifier for the chunk 144.

The system 100 can generate each chunk 144 on demand, such as by execution of a query interpreted by the selector 136. The selector 136 can represent the chunk 144 as a relational table or view mapping the chunk identifier 152 to a set of atomic unit identifiers 156 and one or more chunk-level attributes 148. In some implementations, the chunk 144 can be a dynamically generated result set rather than a persistently indexed entity within the corpus. For example, a relational join expression may compute grouping keys based on text span boundaries or bounding box coordinates and produce a corresponding chunk 144 for downstream use in ranking or display operations. Each chunk 144 can provide the basis for context aggregation, cross-modal enrichment, or temporal correlation of atomic-level data during retrieval.

For example, the chunk 144 can include or be represented as including one or more chunk attributes 148. The chunk attributes 148 can include chunk metadata. The chunk attributes can include relevance scores, embeddings, text representations, or bounding boxes, for example. The chunk attributes 148 can capture aggregated or derived metadata representing properties associated with each chunk 144. In some implementations, the chunk attributes 148 can include precomputed or dynamically computed values produced through aggregation over one or more atomic attribute fields. For example, chunk attributes 148 can include mean or maximum relevance scores, combined embedding vectors, average OCR confidence scores, or bounding box aggregates derived from constituent atomic units.

The selector 136 can access or compute chunk attributes 148 to rank, filter, or recombine chunks within a retrieval query. The selector 136 can maintain the chunk attributes 148 in a relational table that stores the chunk identifier 152 as a primary key and associates each aggregated attribute value with the corresponding chunk identifier through join operations. In some implementations, the selector 136 can perform join operations across the relational table and one or more auxiliary tables that contain atomic unit identifiers or intermediate aggregation results. For example, the selector 136 can execute a join between a chunk attribute table and an atomic unit table to compute aggregated fields such as mean embedding vector values, cumulative bounding box regions, or combined relevance scores associated with each chunk identifier 152.

The selector 136 can update or regenerate the chunk attributes 148 during query evaluation to reflect relational aggregations that derive from atomic-level attributes 132, allowing each chunk identifier 152 to reference a coherent set of computed attribute values accessible for downstream selection or ranking operations. For example, calculation of a combined similarity metric from multimodal inputs can generate a chunk attribute representing fused relevance between text and image modalities. Derived chunk attributes 148 can be expressed as relational projections or functions within query definitions that extend or refine retrieval output structure over atomic-level records.

The chunk identifier 152 can serve as a unique key that distinguishes each chunk 144 within the corpus and facilitates relational joins linking chunk-level data to underlying atomic unit records. In some implementations, the chunk identifier 152 can be generated by the selector 136 upon creation of a new chunk view or can correspond to an existing entry within the database 116. For example, a newly computed paragraph-level chunk may be assigned a chunk identifier 152 that links to atomic unit identifiers 156 in a mapping table maintained within the database 116. The chunk identifier 152 can identify a record within a chunk attribute table while maintaining a one-to-many relationship to the atomic unit identifiers referenced from the atomic unit table. In some implementations, relational integrity between the chunk identifier 152 and the atomic unit identifiers 156 can be maintained through foreign key constraints enforced within the schema. For example, a join operation associating a chunk identifier 152 with its atomic unit identifiers 156 can reconstruct the composition of a multi-modal retrieval chunk derived from text, image, or audio atomic units in response to a retrieval request 140.

The atomic unit identifiers 156 can be or correspond to the atomic unit IDs can represent relational references linking atomic units to corresponding chunks 144 and can define the membership of atomic data records used in retrieval. In some implementations, the unit identifiers 156 can associate atomic unit identifiers 124 drawn from text, image, or audio modalities with a specific chunk identifier 152 defining a retrieval grouping. For example, a chunk 144 representing a paragraph may link ten token-based unit identifiers 156 and two image-region identifiers within one mapping table that establishes the complete multimodal context. Each record in the mapping table can include a chunk identifier 152 and one or more atomic unit identifiers 156, which can allow for bidirectional queries from chunk to atomic records or vice versa. In some implementations, the system 100 can access, based on retrieval queries represented by the requests 140, the mapping table to perform join operations that reconstitute full chunk content and attributes for query results. For example, the selector 136 can combine the atomic content associated with unit identifiers 156 to generate reconstructed composite views of text segments, image regions, or audio clips for delivery in response to a retrieval request 140.

As an example, the selector 136 can receive a request 140 that includes the following query with respect to processing document OCR data that includes text and spatial coordinates:

(corpus.chunk(“token”)
.filter(TopK(“confidence”, 10))
.select(text=SimpleStringify( ), bbox=AtomData(“bbox”)))

The selector 136 can perform multi-stage retrieval. For example, the selector 136 can perform a first selection of atomic units and/or chunks 144 according to a first request 140, and can perform a second selection of atomic units and/or chunks 144 according to a second request 140. As an example, a series of sequential requests can specify a first scoring stage using BM25 relevance functions and a second scoring stage for semantic re-ranking using embedding similarity. Each request 140 can be evaluated by the selector 136 to produce or modify the composition of one or more chunks 144 within the database 116 in response to specific data retrieval requirements. As in the following example, the system 100 can perform a first retrieval (e.g., using fast BM25), and can perform a second retrieval by re-ranking candidates with semantic similarity:

(corpus.chunk(FixedSizeChunk(“paragraph”, 100))
.enrich(text=SimpleStringify( )) # Pre-store text for convenience
# Initial retrieval using fast BM25
.filter(TopK(BM25(attr=“text”, query=“my query”), 1000))
# Re-rank top candidates with semantic similarity
.filter(TopK(SemanticSimilarity(attr=“text”, query=“my query”), 10))
.select(text=SimpleStringify( )))

In response to the request 140, the selector 136 can retrieve chunks 144 of atomic units (e.g., based on records 120) that correspond to the “token,” can filter the retrieved chunks 144 for the top ten chunks 144 based on confidence (e.g., with respect to the token), and can output chunk 144 and atomic unit data and/or metadata according to text and bounding box information indicating spatial coordinates to select. As compared to document retrieval systems that treat documents as monolithic objects and/or rely on index-time chunking, the system 100 can thus support rich, multi-granular metadata as first-class attributes that can be queried alongside the document 104.

As noted above, the system 100 can allow for dynamic chunking and/or view-based retrieval. For example, the system 100 can extract atomic units, can store the extracted atomic units in records 120, and can retrieve data from records 120 upon receiving requests 140, which can avoid the need for upfront chunk persistence or re-indexing (including, for example, re-indexing and/or re-chunking each time a distinct query is received). The following example indicates how the system 100 can form chunks 144 from atomic units from a document 104, can enrich the chunks 144 by forming embeddings of the text of the chunks 144, can filter the chunks 144 according to similarity between the embeddings and a query, and can generate an output according to the filtered chunks 144:

(corpus.chunk(FixedSizeChunk(“document”, 100))
.enrich(embedding=BertEmbedding(SimpleStringify( ))) # Embed text
.filter(TopK(BertSimilarity(“embedding”, query=“my query”), k=10))
.select(“id”))

Table 2 below provides examples of greater retrieval speed as achieved by the system 100, such as for end-to-end retrieval speed including indexing.

| | |
|---|---|
| NFCorpus | TREC-COVID |
| (3600 documents) | (171000 documents) |

| | Pyserini | System 100 | Pyserini | System 100 |
|---|---|---|---|---|
| Max time | 5.24 | 1.16 | 12.74 | 17.12 |
| (seconds) | | | | |
| Mean time | 4.54 | 1.09 | 12.16 | 16.46 |
| (seconds) | | | | |
| Min time | 4.17 | 1.05 | 11.47 | 15.80 |
| (seconds) | | | | |

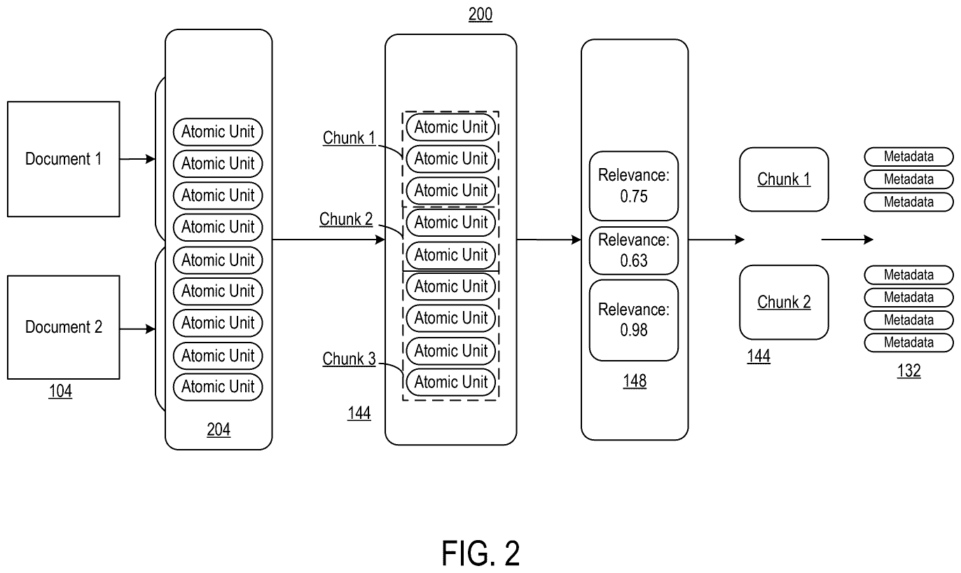

FIG. 2 depicts an example of a process 200 of data retrieval that the system 100 can perform. For example, the system 100 can perform the process 200 to generate atomic units and/or in response to a request 140 for data from documents 104.

For example, the system 100 can cause parsing of a first document 104 and a second document 104 to extract a plurality of atomic units, such as words, tokens, pixels, or audio samples, for example and without limitation. The atomic units can form a corpus 204; for example, the system 100 can maintain the corpus 204 in the database 116. The system 100 can define a first chunk 144, a second chunk 144, and a third chunk 144 from the atomic units, each chunk 144 corresponding to associated atomic units.

As depicted in FIG. 2, the system 100 can determine (e.g., based on one or more criteria indicated by the request 140) chunk attributes 148, such as relevance scores for atomic units of the chunks with respect to the request 140. The system 100 can determine a respective chunk attribute 148 for each chunk 144, which can be based on atomic unit attributes 132 of the atomic units of the respective chunks 144.

The system 100 can filter the chunks 144 according to the chunk attributes 148, such as to select the first and third chunks 144 (e.g., based on a threshold relevance score, or a request to select the top two chunks 144). The system 100 can provide output that includes data and/or metadata of the atomic units of the selected chunks 144, such as requested atomic unit attributes 132, such as text contents, token location information, pixel values, for example and without limitation; such data can be accessed regardless of how it was retrieved.

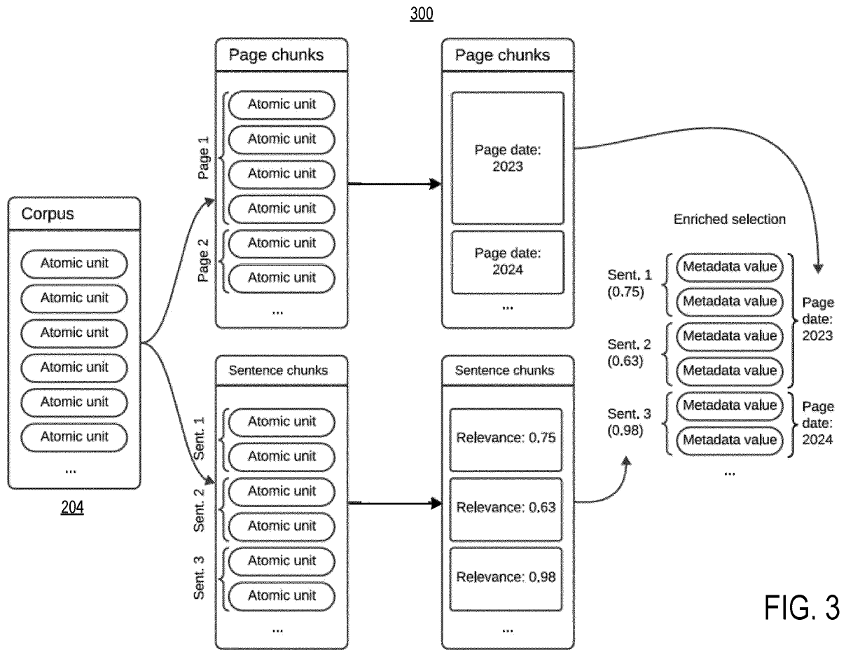

FIG. 3 depicts an example of a process 300 that the system 100 can perform. For example, in the process 300, the system 100 can define multiple types of chunks 144 for a given corpus 204, rather than requiring re-indexing and/or multiple sets of chunks to be stored.

For example, the system 100 can generate each of page chunks 144 (e.g., chunks 144 corresponding to atomic units that make up respective pages of a given document 104) and sentence chunks 144 (e.g., chunks 144 corresponding to atomic units that make up respective sentences of a given document 104) based on the atomic units of the corpus 204. The system 100 can determine, for each of the page chunks 144, chunk attributes 148 such as the page date of the respective page one (2023) and page two (2024). The system 100 can determine, for each of the sentence chunks 144, chunk attributes 148 such as relevance scores of each of the respective sentences with respect to a query, for example. As depicted in FIG. 3, the system 100 can generate an enriched output that includes each of the page-level chunk attributes 148 of page dates as well as the sentence-level chunk attributes 148 of sentence-level relevance scores.

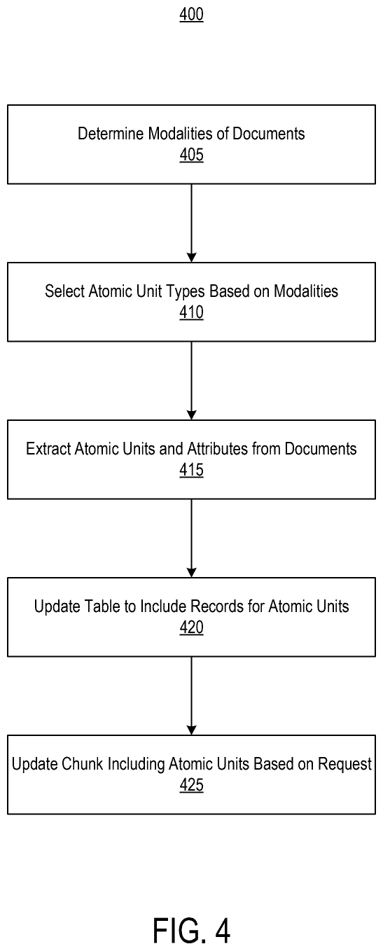

Referring now to FIG. 4, illustrated is a method 400 of atomized relational retrieval, in accordance with one or more implementations. The method 400 can be executed, performed, or otherwise carried out by any of the computing systems or devices described herein. In brief overview of the method 400, the method 400 can include determining modalities of documents 405, selecting atomic unit types based on modalities 410, extracting atomic units and attributes from documents 415, updating a table to include records for atomic units 420, and updating a chunk including atomic units based on a request 425.

At 405, the method 400 can include determining modalities of documents. The modalities can be determined subsequent to ingestion of the documents, including in continuous or batch processing of documents or portions of documents. The system can determine a modality type for each document among a plurality of documents to establish the appropriate processing pipeline. In some implementations, the system can classify documents as text, image, audio, or other modalities based on embedded metadata, format signatures, or document headers. The determination can occur as an initial stage preceding atomic unit extraction so that subsequent parsing operations are aligned with the detected modality type. In some implementations, the system can perform this determination immediately after receiving the documents from a file ingestion interface or a corpus loader component. In some implementations, multiple modalities are determined for any given document, e.g., based at least on the given document having data of multiple modalities, such as both text and image content.

At 410, the method 400 can include selecting atomic unit types (e.g., for data of the documents) based on the determined modalities. For example, the system can select an atomic unit type for each document according to the determined modality for each document. In some implementations, textual documents can be determined to have atomic unit types of text or tokens, image documents can be determined to have atomic unit types of pixels or image regions, and audio documents can be determined to have an atomic unit type of audio samples. For example, a mapping function can associate identified modality indicators with corresponding parsers or atomic unit generators that perform segmentation or feature extraction. The selection can occur after modality identification and before extraction and table updates, providing consistency across downstream relational operations. In some implementations, the system can reference a stored configuration that links text modality with a tokenizer, image modality with a pixel sampler, and audio modality with a waveform segmenter, ensuring alignment between parsing logic and data modality.

At 415, the method 400 can include extracting atomic units and attributes of the atomic units from the documents. For example, the system can parse unstructured data of each document according to its selected atomic unit type to derive atomic units and associated attributes. In some implementations, each extracted unit can include or be associated with contextual metadata such as positional coordinates, timestamps, or confidence values generated by the modality-specific parser. The extraction can occur after completion of atomic unit type selection and before relational table updates, such as to preserve ordered data flow across pipeline stages. In some implementations, parser output pipelines can compute embeddings, coordinate mappings, or segmentation indices as atomic attributes prior to insertion into the relational corpus.

At 420, the method 400 can include updating a table to include records for atomic units. For example, the system can update a relational table and/or database to insert a record for each extracted atomic unit. In some implementations, each record can store a unique identifier for the atomic unit, a document identifier for the document from which the atomic unit is extracted, content (e.g., data) of the atomic nuit, and one or more attributes of the atomic unit, such as one or more attributes derived from the extraction process. For example, when processing a PDF, a token extracted from a page can be recorded as a new row including a token ID, textual content, and positional coordinates that identify its position in the source document. The table update can occur after atomic unit extraction and before any chunk generation or retrieval queries. In some implementations, the table update can be implemented using relational insertion operations or batch appends to a corpus-wide atomic table to maintain a persistent mapping between documents, atomic identifiers, and extracted attribute fields.

At 425, the method 400 can include generating and/or updating a chunk to selected atomic units, such as based on a request or query. For example, the system can output, in response to a retrieval request referencing one or more atomic units, at least one record corresponding to a dynamically defined chunk. In some implementations, the system can generate the chunk definition using one or more selection criteria such as relevance, position, or embedding similarity specified in the request. For example, a query can specify selection of tokens exceeding a confidence threshold or combined page regions containing related features across modalities. The chunk update can occur after the atomic unit table is populated and can be triggered by execution of a retrieval query requiring multi-resolution or multi-stage output. In some implementations, the system can update the chunk by defining a relational view or a temporary table that references atomic unit identifiers and corresponding chunk-level metadata such as bounding-box aggregates, semantic embeddings, or calculated relevance values.

Systems and methods as described herein can be implemented by any of various neural networks and/or machine learning models. These can include, for example and without limitation, one or more neural networks (or layers, nodes, weights, and/or biases thereof), convolutional neural networks, recurrent neural networks, attention networks, transformer networks, encoders, decoders, sequence to sequence models, generative models, pretrained models, diffusion models, multimodal models, generative adversarial networks, or various combinations thereof, which may be configured (e.g., trained, fine-tuned, having transfer learning performed, updated or operated by in-context learning, examples, or prompting, etc.) through operations such as supervised learning, self-supervised learning, or unsupervised learning. Systems and methods as described herein can be implemented in any of various artificial intelligence architectures or processing pipelines, including, for example, agentic pipelines, retrieval-based pipelines (e.g., retrieval-augmented generation), or various combinations thereof.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein can be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor can be a microprocessor, or, any conventional processor, controller, microcontroller, soc (system on chip), som (system on module) or state machine. A processor also can be implemented as a combination of computing devices, such as a combination of a DSP and a microprocessor, a plurality of microprocessors, one or more microprocessors in conjunction with a DSP core, or any other such configuration. In some implementations, particular processes and methods can be performed by circuitry that is specific to a given function. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. The memory can be or include volatile memory or non-volatile memory, and can include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure can be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein can be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and that such variations are intended to be encompassed by the present disclosure.

What is claimed is:

1. A system comprising:
one or more processors to:
receive a plurality of documents comprising unstructured data;
determine a type of modality for each document of the plurality of documents;
route each document to a corresponding parser based on the type of modality for the document;
select an atomic unit type for parsing each document based on the type of modality;
parse at least the unstructured data of each document, using the corresponding parser, according to the atomic unit type to extract a plurality of atomic units from the document and a plurality of attributes of each atomic unit of the plurality of atomic units;
update a table in a relational database to include a record for each atomic unit of the plurality of atomic units, the record comprising a unique identifier of the atomic unit, a document identifier linking the atomic unit to the document from which the atomic unit is extracted, and the plurality of attributes of the atomic unit; and
output, in response to a request for a chunk of one or more atomic units, at least one record corresponding to the chunk, the chunk dynamically defined responsive to the request.

2. The system of claim 1, wherein the one or more processors are to dynamically define the chunk as a selection of the one or more atomic units based on one or more criteria indicated by the request.

3. The system of claim 1, wherein the one or more processors are to represent the chunk as a first table comprising one or more chunk-level attributes of the chunk and a second table comprising an identifier of the chunk and the unique identifier of each of the one or more atomic units of the chunk.

4. The system of claim 1, wherein the one or more processors are to output the chunk, based on the request, to include atomic units of a plurality of types of modalities.

5. The system of claim 1, wherein:
the request is a first request indicating one or more first criteria for selection of the one or more atomic units; and
the one or more processors are to output, responsive to a second request indicating one or more second criteria, a subset of the one or more atomic units of the chunk.

6. The system of claim 1, wherein the one or more processors are to provide, for generation of the request, a function to select the one or more atomic units according to at least one of a content attribute of the one or more atomic units or a metadata attribute of the one or more atomic units.

7. The system of claim 1, wherein the one or more processors are to output the at least one record to include each of text data and image data.

8. The system of claim 1, wherein the one or more processors are to generate the plurality of attributes of each atomic unit to include a location of the atomic unit in the document from which the atomic unit is extracted.

9. The system of claim 1, wherein the plurality of documents comprise a plurality of types of modalities including the type of modality, the plurality of types of modalities including at least a text type and an image type.

10. The system of claim 1, wherein the one or more processors are to determine the plurality of attributes of each atomic unit to include at least one of a text value or a pixel color of the atomic unit, and at least one of a position or a time stamp of the atomic unit.

11. The system of claim 1, wherein the atomic unit type comprises a text token type, an image pixel type, or an audio sample type, and the one or more processors are to use the correspond parser to perform tokenization, pixel identification, or audio sampling of the document.

12. The system of claim 1, wherein the one or more processors are to:
determine, based on the request, at least one of a relevance score, an embedding, a text representation, or a bounding box for the chunk.

13. A method comprising:
receiving, by one or more processors, a plurality of documents comprising unstructured data;
determining, by the one or more processors, a type of modality for each document of the plurality of documents;
routing, by the one or more processors, each document to a corresponding parser based on the type of modality for the document;
selecting, by the one or more processors, an atomic unit type for parsing each document based on the type of modality;
parsing, by the one or more processors, at least the unstructured data of each document, using the corresponding parser, according to the atomic unit type to extract a plurality of atomic units from the document and a plurality of attributes of each atomic unit of the plurality of atomic units;
updating, by the one or more processors, a table in a relational database to include a record for each atomic unit of the plurality of atomic units, the record comprising a unique identifier of the atomic unit, a document identifier linking the atomic unit to the document from which the atomic unit is extracted, and the plurality of attributes of the atomic unit; and
outputting, by the one or more processors, in response to a request for a chunk of one or more atomic units, at least one record corresponding to the chunk, the chunk dynamically defined responsive to the request.

14. The method of claim 13, comprising defining the chunk as a selection of the one or more atomic units based on one or more criteria indicated by the request.

15. The method of claim 13, comprising structuring, by the one or more processors, the chunk as a first table comprising one or more chunk-level attributes of the chunk and a second table comprising an identifier of the chunk and the unique identifier of each of the one or more atomic units of the chunk.

16. The method of claim 13, wherein:
the request is a first request indicating one or more first criteria for selection of the one or more atomic units; and
the method comprises outputting, by the one or more processors, responsive to a second request indicating one or more second criteria, a subset of the one or more atomic units of the chunk.

17. The method of claim 13, comprising providing, by the one or more processors, for generation of the request, a function to select the one or more atomic units according to any of a content attribute of the one or more atomic units or a metadata attribute of the one or more atomic units.

18. The method of claim 13, comprising generating, by the one or more processors, the plurality of attributes of each atomic unit to include a location of the atomic unit in the document from which the atomic unit is extracted.

19. The method of claim 13, comprising determining, by the one or more processors, the plurality of attributes of each atomic unit to include at least one of a text value or a pixel color of the atomic unit, and at least one of a position or a time stamp of the atomic unit.

20. A non-transitory computer-readable medium comprising machine-readable instructions that when executed by one or more processors, cause the one or more processors to execute operations comprising:
parsing one or more documents, according to one or more modalities of the one or more documents, to extract a plurality of atomic units from the one or more documents and a plurality of attributes of each atomic unit of the plurality of atomic units;
updating a database to include a record for each atomic unit of the plurality of atomic units, the record comprising a unique identifier of the atomic unit, a document identifier linking the atomic unit to the document from which the atomic unit is extracted, and the plurality of attributes of the atomic unit; and
outputting, based at least on a request for a chunk of one or more atomic units, at least a portion of at least one record corresponding to the chunk.
